(19) United States
(12) Patent Application Publication
(10) Pub. No.: US 2026/0021668 A1
(43) Pub. Date: Jan. 22, 2026

(54) SYSTEM AND PROCESS FOR IN-LINE DIGITAL PRINTING

(71) Applicant: NUR DIGITAL TEX LTD, Magshimim (IL)

(72) Inventors: Gregory RODIN; Eliav PRIEL, Herzliya (IL); Moshe NUR, Magshimim (IL)

(73) Assignee: NUR DIGITAL TEX LTD, Magshimim (IL)

(21) Appl. No.: 18/997,258

(22) PCT Filed: Aug. 17, 2023
(86) PCT No.: PCT/IL2023/050868

§ 371 Date: Jan. 21, 2025

Related U.S. Application Data
(60) Provisional application No. 63/371,788, filed on Aug. 18, 2022.

(51) Int. Cl. B41J 13/08; B41J 3/407; B41J 11/00; B41J 13/10; B41J 29/393; D06P 5/00

(52) U.S. Cl. CPC B41J 13/08; B41J 3/4078; B41J 11/0022; B41J 11/0024; B41J 11/009; B41J 13/103; B41J 13/106; B41J 29/393; D06P 5/002

(57) ABSTRACT

The technology generally concerns an in-line system and process for forming an image on an object.

### TECHNOLOGICAL FIELD

The invention generally contemplates an in-line digital printing system.

### BACKGROUND OF THE INVENTION

Digital printing is a printing technique commonly used for on-demand printing of patterns on a variety of substrates such as cellulose papers, fabrics and the like.

When printing an aqueous ink formulation on such absorptive substrates, the degree of liquid absorption and the degree of interaction of the substrate, e.g., fibers, with the ink formulation is likely to impact the quality of the image formed. Thus, to increase receptivity and fixation of the aqueous ink formulation to the absorptive substrate, a coating composition or a pretreatment formulation is typically applied to the substrate, in advance of the printing, in a process referred to as a pretreatment process. This process endows the surface receptive of the ink formulation and further provides or imparts certain characteristics to the substrate.

Once the receptive layer has been formed, the surface is subsequently overprinted with a layer or a pattern of the ink formulation. As that ink layer or pattern is designed to affix to the underlying pretreated surface, the ink formulation is applied to the pretreated surface several hours after the pretreatment process has been completed, to ensure proper drying of the surface. This usually leads to good results with respect to the visual characteristics of the printed surface. However, such an off-line process, whereby the pretreatment process and the ink patterning or printing are not completed in the same step sequence, and may also be achieved using different printing or deposition devices, suffers from a variety of disadvantage. Of these, the rather long time required for carrying out a complete printing session may be the most industrially burdensome.

Therefore, it has been suggested to form the ink pattern or layer directly after the pretreatment process, in a single process referred to as an “in-line process”. While in-line processes reduce the time necessary to complete a single printing session, the ink pattern or layer is applied on a pretreatment layer that is still wet. The wet-on-wet printing conditions are advantageous as the drying time is eliminated, and as the printing takes place in a single step. However, wet-on-wet printing introduces difficulties that require proper parameter/conditions selection, relating both to the ink compositions used and the printing protocols.

### GENERAL DESCRIPTION

The technology disclosed herein is aimed at shortening printing times in in-line systems comprising both pretreatment and printing steps and improving wet-on-dry printing on a variety of media. The technology disclosed herein allows for speedy in-line and simultaneous manufacturing of printed objects of same or different materials, while also reducing manufacturing costs and improving printing resolutions.

The technology generally concerns a printing system comprising a conveyor system and a plurality of processing stations. The conveyor system is equipped with two or more or a plurality of closed-loop tracks, which may be arranged as endless tracks, that are optionally positioned to run in parallel or adjacent to each other. Each of the tracks defines an object stream that is independently controlled, configured and operable to transition through or under or within a plurality of functional or processing stations. Each of the object streams comprises a plurality (typically two or more) of carriages or platens or support surfaces that are configured, sized and shaped, or may be generally adapted to receive thereon an object to be printed on. Each of the objects is independently identified based on the carriage or platen on which it is positioned and its treatment along the processing line is predetermined. In other words, each object may be pretreated and subsequently printed based on a predetermined processing profile or printing profile that is associated therewith. The processing profile identifies an object profile (size, shape, material, and other parameters relating thereto) with a pretreatment formulation and deposition conditions (temperature, pressure, etc) relating thereto, printing or ink formulation and deposition conditions (temperature, pressure, etc) relating thereto, image to be formed on the object (including its position on the object), as well as other parameters.

As further disclosed herein, each of the plurality of processing stations may be configured to operate with respect to the object. In other words, each of the processing stations is positioned with respect of a moving support system carrying an object.

The closed loop in-line system of the invention is structured to occupy a minimal space and operate autonomously and continuously to produce patterned objects or images. Thus, the system may be further equipped with electrical wiring and a controller, as well as one or more ink reservoirs.

According to an aspect of the invention there is provided a closed-loop system for digital printing, the system comprising a pretreatment station for applying an aqueous pretreatment formulation to a surface of an object to produce a wet pretreatment layer, a drying tool for drying the aqueous pretreatment layer; at least one inkjet nozzle or deposition tool that positioned proximate the object and configured for forming an image (by jetting ink droplets) onto the dry pretreatment layer formed on the object; and an ink drying tool configured to at least partially dry the ink on the dry pretreatment layer to produce the dry image. In some configurations, the drying tool may be provided off-line and may thus not be part of the system.

In some embodiments, the system comprises a conveyor system comprising two or more closed-loop tracks, each track defining an object stream independently controllably transitioned by the conveyor system through a plurality of processing stations, each of the closed-loop tracks being equipped with a plurality of support surfaces (or carriages or platens) adapted (or configured or structured or shaped) to receive an object to be printed on.

Also provided is a printing system comprising a conveyor system and a plurality of processing stations,
the conveyor system comprising one, two or more closed-loop tracks, each track defining an object stream independently controllably transitioning by the conveyor system through the plurality of processing stations, each of the closed-loop tracks being equipped with a plurality of support surfaces adapted (or configured or structured or shaped) to receive an object (i.e., an object to be printed on);
the plurality of processing stations comprises a loading zone (e.g., comprising a loading/unloading station(s)), a pretreatment station equipped with one or more film deposition tools and one or more drying tools; a printing station equipped with one or more print heads or a print head assembly or an array of print heads arranged and operable to deposit through at least one nozzle an ink formulation on a surface region of the object in each of the object streams.

The system further comprises a controller operable for instructing independent treatment or processing of each object positioned on a support surface based on a predetermined processing profile that is associated with the object (and determined based on the object size, shape, material composition, prior treatment protocols, the image to be formed thereon, etc). The processing profile defines a pretreatment formulation and deposition conditions (temperature, pressure, etc) to be used with or applied to the object, a printing or ink formulation and deposition conditions (temperature, pressure, etc) to be used with or applied to the object, an image to be formed on the object (including its position on the object), as well as other parameters relating to any of the processing conditions steps.

A system of the invention comprises a plurality of closed-loop tracks, which are endless, namely cyclic or having no end, each is independently configured to manage a stream of objects from a loading station through one or more in-line processing stations and back to the loading station where the object is unloaded from the particular closed-loop track and a new object may be loaded. Each of the closed-loop tracks is provided with a plurality of support surfaces, typically in a form of flat platform surfaces, carriages, platens or other sized or shaped surfaces, that are aligned with respect to support surfaces in another object stream and with respect to any of the processing stations, and are synchronized to move all object streams in the same pace or rate and slow down or cease movement of the streams once an object reaches a processing station for a period of time sufficient to allow the printing process step and/or the pre-treatment step and/or the loading and unloading step to be carried out.

All closed-loop tracks are housed within a three-dimensional digital printing process space or a housing. To compact all processing stations in as small a space as possible, the different stations may occupy different levels or regions of the housing, such that at least one of the processing stations may be provided at a level that is different (lower or higher) to a level defined by another of the processing stations.

The various processing stations are shared by all object streams traversing them (moving through, or within or under the stations). The processing stations are typically provided upstream or in the direction of movement of the conveyor and objects (at a position that is after or subsequent) to a loading zone or station (and downstream to or before an unloading station). The processing stations may include any one or more of a pretreatment station, a printing station, optionally a curing or drying station and may include other station as a configuration of the system may require. Typically, in a single closed-loop run, any of the support surfaces, e.g., flat platform surfaces, fixedly mounted with an object to be processed according to aspects and embodiments of the invention, is moved through the different sections of the track, so that the object is treated in each of the stations along the track. A pretreatment station typically positioned upstream to a loading station is configured and operable to prime the object surface to receive thereon an ink formulation. Pretreatment may involve deposition of a film of an aqueous pretreatment formulation on a surface region of the object and drying said film. The particular pretreatment formulation used may vary between objects and may depend on the processing profile of the object or relevant thereto. Similarly, the drying of the wet film formed on the object surface may vary based on the formulation used and the degree of dryness that is desired, or the composition or nature of the object in case thermal drying is required.

A printing station provided along the closed-loop track, upstream or subsequent to the pretreatment station, is configured and operable for printing an image on the pretreated or primed surface by one or more printing head units or by at least one array of printing head units. As with the pretreatment step, the image printed and the conditions used may vary between objects based on each object processing profile.

The closed-loop track may further include a curing or a further drying station, upstream to (or immediately following) the printing station and before the unloading station. The curing or drying station may include one or more or an array of heating or curing elements such as UV or IR lamps, heated elements or surfaces (which may include heating surfaces below the object or above the object), hot air sources (configured to blow hot air over the surface of the printed object), etc, that are operable to direct UV or thermal radiation towards the pretreated and/or printed surface region of an object traversing through the drying station. Presence of at least one heating or curing element that is a UV source or an IR source would depend on whether, for example, any of the printing process steps carried out on a system of the invention utilizes a solvent-based or a water-based formulations. In some configurations, a UV source and an IR or a thermal irradiation source are provided, wherein operation of either would be preselected based on the processing protocol identified for each object or a plurality of objects, as disclosed herein. Typically, systems of the invention are configured and operable for use with water-based inks. Thus, a UV source may not be needed or used.

In some cases, a system of the invention does not include a drying or a curing station. In such cases, drying of the printed surface may be achievable offline.

The loading and unloading stations may occupy a single (or the same) “loading zone” that is configured to receive, manually or automatically, for every object stream, an object (namely—an object for every support surface, optionally in a form of flat platform surfaces) or a plurality of objects to be processed according to a predefined processing protocol, and to allow for unloading of an object after the object has transitioned through the various processing stations and completed a travel along the closed-loop track. The loading zone may be provided with a plurality of objects to be mounted on the support surfaces, and equipped with mechanical means for loading and/or unloading the objects. The mechanical means may be, for example, a multiple axis robotic unit which includes a robotic arm movable in all directions and optionally a rail or a base to enable movement of the robotic arm to maximize degrees of freedom. The movement of the robotic arm and the support surfaces may be synchronized with the flow rate of the objects.

An exemplary robotic arm is any industrial robot used for transitioning objects from one region to another. Such robotics are manufactured by robot manufacturers such as KUKA Robotics.

The support surfaces onto which the objects are mounted or onto which the objects are positioned are typically flat platform surfaces of a size and shape selected to meet at least one structural parameter relating to the object each platform surface is intended to carry. The support surface may be configured as a carriage or a platen, operatively associated to the conveyor in a position relative to another carriage in the track. Each support surface or platen is attached to the conveyor by one or more clamp members or pins or other members extending from the conveyor track and which can securely and firmly associate to an underside region of the support surface. For example, the support surfaces may be attached to one or more clamp members by fasteners which extend through aligned openings formed in the underside of the support surface.

An object positioned onto a support surface may be simply placed on the surface or may be fixedly associated with the surface. In other words, in some configurations, the object may be fastened, attached, or placed within a holding frame or support so as to be firmly held and not readily movable or disturbed when transitioning from one station to another; yet easily detachable or unfastenable once printing is completed and the object arrives at the unloading station. The association or fastening of the object to the support surface may be achievable in a variety of mechanical or magnetic or electric means. For example, the association may involve magnetic attraction or electric attraction to the support surface, or may include mechanical fastening, wherein the object is placed within a frame or in a locking mechanism that reversibly attaches the object to the support surface.

The position of the object and thus the holding device or frame on the support surface may be defined by coordinates which form the work offset for printing on the object when placed in the printing system. Alternatively, the position of the object may be determined by utilizing an overhead projector which is configured and operable to display onto the surface of the object at least one positioning coordinate for accurately aligning the object on the support surface or within the holding means.

The support surface may be configured to simultaneously carry one or two or more objects and transition said two or more objects along the processing stations defined along the closed-loop track. Alternatively, each support surface may be associated with a single object.

In other configurations, each of the closed-loop tracks may be associated with a plurality of support surfaces positioned along the track such that at any time point the stream of objects may include a plurality of objects in transition along the same closed-loop track from one processing station to another. In such configurations, all support surfaces in the system may be in transition along their respective track or static within a processing station such that each of the objects provided on each of the support surfaces undergoes treatment (pretreatment, printing, drying, etc) at the respective processing station. The speed of the conveyor may be selected per project or may be kept constant for all projects. Typically, the speed of conveyor movement or transition is between 0.1 m/sec to 1 m/sec. In some cases, the speed is between 0.5 and 1 m/sec, or between 0.6 m/sec.

The distance between any two support surfaces along the same track may be set such that all or a majority of the support surfaces traverse at least one of the processing stations (e.g., pretreatment, printing and other stations) at the same time. In other words, while one support surface may traverse a pretreatment station, at the same time, another may traverse the printing station, etc. In some configurations, the distance between any two support surfaces along a given track may be between 1 and 2.5 meters. In some embodiments, the distance may be between 1 and 2 meters or between 1.5 and 2 meters.

The conveyor defining a travel path along which the two or more object streams advance may include two or more drive pulleys that are electrically powered.

The conveyor may include a conventional support frame with a series of vertically extending legs. Outer horizontal support beams may extend longitudinally between the legs and cross beams may extend transversely between the legs. The drive pulleys may include an upstream pulley and a downstream pulley that are rotatably supported by a frame. A conveyor drive servo motor may be drivingly engaged with one of the pulleys, to impart movement to the conveyor, in a manner known in the art.

The conveyor may be configured to affect a translational motion along each of the closed-loop tracks for bringing the objects from one processing station to another, irrespective of the position of one processing station in relation to another. This allows for achieving all processing steps of the printing process simultaneously within a single printing system.

Each of the closed-loop tracks comprises a section, typically being upstream to the pretreatment station, defining an image forming station or a printing station. The printing station is typically equipped with a printing assembly configured and operated for printing on a surface region of each of the objects traversing the printing station. The printing assembly may include one or more print head units or a print head assembly, or an array of a plurality of print head units. The units may be arranged along a single axis above and perpendicular to a translation axis defined by a path of the conveyor and the support surfaces mounted thereon traversing the printing station, or arranged in spaced apart regions of the printing station along the path of the conveyor and the support surfaces to allow for simultaneous or sequential printing on different regions of the object surface.

Each of the printing head units may include a number of jet nozzles for ejecting an ink formulation in a direction of the surface of the object. A printing head assembly may comprise a plurality of jet nozzles configured to eject same or different ink formulations. For example, a first group of jet nozzles may be adapted for ejecting a first type of an ink onto the surface of the object, and second group of jet nozzles for ejecting a second type of an ink onto the surface of the object. The number of jet nozzles may vary and may correspond with a plurality of ink canisters or reservoirs used.

The print heads may be configured to act as a multi-pass for the correction of printing defects, or to make prints of greater complexity. The detection of printing defects may be achieved by such means as optical graphic assistance means that are connected to a central processing and control unit of the printing system that may instruct the printing elements, e.g., printing bridge, to move over the defected print and correct the identified defects.

In some configurations, the printing assembly is provided on a movable support bridge or on a raised movable platform that is positioned above and optionally perpendicular to an axis defined by the path of the conveyor and the support surfaces mounted thereon. The printing assembly may be configured and operable to affect movement along the axis of the bridge, in a direction perpendicular to the axis of the bridge and/or to a direction above and below the axis of the bridge, namely in all directions with respect to the bridge. Printing may therefore proceed by moving the print head assembly in any direction in relation to the surface of the object, optionally in a continuous mode, while maintaining the support surface static during printing. Printing may also proceed differently for each object traversing the printing station.

The movable support bridge on which the printing assembly may be mounted is supported on a pair of two parallel fixed support tracks or beams and may be configured for slidingly transition (back and forth along the same axis) between any two points along the fixed support tracks, within the printing section, along the axis defined by the path of the conveyor and the support surfaces mounted thereon. The movement of the bridge combined with movement of the printing assembly allows for a multi-pass for achieving correction of printing defects, or for making prints of greater complexity.

The movable support bridge may be provided with a linear direct drive motor that is configured to provide a direct linear motion, transitioning the bridge with a high speed, high precision, zero backlash and without mechanical transmission elements such as gearboxes, rack and pinions, or belt and pulley systems. The motor controllably and directly drives the printing assembly mounted thereon on a pair of shafts extending from the motor in opposite directions, defining a length of the bridge.

The system may further comprise a digital front-end processor (DFE) or a communication processor, a print engine for applying an ink formulation to the printing station, along with one or more post-printing finishing tools, which may include a top coating tool, a glosser tool, a lamination tool and other post processing enablers. The DFE may be configured to receive input electronic files composed of images from external input devices. These images may be any visual representation of pictures, texts, graphics and others. The communication processor may involve function processors, such as raster image processors, image positioning processors, image manipulation processors, color processors, image storage processors and others.

The pretreatment station being positioned generally between the loading zone and the printing station, typically immediately after the loading zone, may include one or a plurality of film forming tools for depositing a film of one or more types of pretreatment formulations onto a surface region of the object surface intended to be patterned or printed on and one or more drying tools for drying each of the films of the pretreatment formulation or for increasing the film viscosity to a degree suitable for receiving an ink formulation thereon. In some configurations, a single film forming tool and a single drying tool are used for priming objects in each of the two or more object streams. In other configurations, each object stream is assigned with an independently controlled film forming and drying tools (one or more).

Each film forming tool may be a printing assembly configured and operable to form the film or any other deposition tool such as an electrically operated spraying unit, or a brushing unit, etc that are configured to deposit a film of a pretreatment formulation on a region of the object on which an image is to be formed. The film is typically nanometric or micrometric in thickness, but in some cases may have a greater thickness. The film is uniformly formed on the surface of the object. Typically, the pretreatment formulation is deposited on a surface region of the object based on the predetermined processing protocol identified for the object. The drying conditions may be similarly selected.

The drying tools may be one or more heat emitting sources, which may be in a form of IR lamps or heating members or heating surfaces or hot air emitters. These emitters may be located above and/or below the object or the support surface on which the object is positioned, and operated to emit thermal energy suitable for drying the deposited (aqueous) formulation. Alternatively or additionally, the drying tools may involve a heating press member configured and operable for pressing the film formed of the pretreatment formulation so as to flatten the surface, particularly in case the surface is comprised of fibers, e.g., a fabric, and improve both adhesion of the pretreatment formulation to the surface, and of the ink formulation to the dry film. Irrespective of the type of the drying tools used, in some embodiments, the tools are selected to emit thermal energy sufficient to heat the surface of the object to a temperature not exceeding 200° C. In some configurations, the surface may be heated to a temperature between 9° and 200° C., or between 10° and 200° C., or between 10° and 180° C., or between 9° and 180° C.

Thus, in some embodiments, the pretreatment station may comprise a heating press member that is configured to press against the wet film formed on the object, thereby achieving its drying. The press member may be a top member, ram, press or lid of a shape and size that correspond to the dimensions and shape of the surface to be heated. The shape and size of the heating press member may be identical to that of a support surface used for carrying the object. The heating press member may be equipped with downwardly oriented piston capable of pushing the press in a direction of the support surface such that the pressure applied to the support surface or the object provide thereon is between 2 and 7 bars. Irrespective of the means by which the press is operated or configured, the pressure to be applied is between 2 and 7 bars, or between 1 and 6 bars, or between 3 and 6 bars, or between 3 and 5 bars, or any pressure lower than 7 bars or 6 bars.

The press is further provided with a heating unit for heating a surface region thereof that is configured to contact the film of pretreatment formulation. The heating unit is selected to heat the surface of the press so as to delivery thermal energy sufficient to raise the temperature of the object, e.g., fabric, to a temperature between 9° and 200° C., or between 10° and 200° C., or between 10° and 180° C., or between 9° and 180° C.

In some embodiments, the press is configured and operable to press the object against the support surface, inducing pressures between 2 and 7 bars, as further defined and selected above, at a temperature between 9° and 200° C., or as defined and selected above.

In some configurations, the heating press member may be static and the support surface may be configured to move into a pressing position, such that the wet surface of the object is in contact between the heated surface of the member. In other configurations, the heating press member may be configured to move towards and press onto the wet surface. The pressing force applied, as disclosed herein, by the heating press member uniformly acts on the wet surface and the applied pressure is continued for a period of time sufficient to flatten and dry the deposited wet film. The period of time may be between 1 see and several seconds, e.g., between 1 and 120 seconds. In some embodiments, the pressure is applied for a period of between 10 and 120 seconds, or between 10 and 100 seconds, or between 10 and 90 seconds, or between 15 and 120 seconds, or between 15 and 90 seconds. Thereafter, the pressure is lifted, e.g., the press member is lifted off or removed, and the object progresses along the processing line.

Alternatively to a heated pressing member, drying may be achieved by transferring the wet object through a set of heated pressing rollers.

In some embodiments, the system is equipped with a source of hot air having a temperature above room temperature, that is configured to flow a hot air over the surface of the wet film. In some cases, drying is achieved by heated air flow followed by pressing with a heating press member, as disclosed herein.

The film forming tools need not deposit a film over the full surface of the object. Each of the tools may be independently configured and operable to pattern the pretreatment formulation on specific regions of the surface only where ink patterning is intended. Irrespective of the shape and the details of the film, a drying tool may be configured and operable to affect heating only after the film forming tool has retracted following deposition of the pretreatment formulation.

In some embodiments, the drying of the pretreatment formulation may be performed sufficiently rapidly so as to prevent beading and to leave a continuous film having a desired thickness. Typically, the thickness of the pretreatment layer or film is nanometric and may be at most between 10 and 200 nm. The dried pretreatment film onto which an ink formulation is subsequently deposited is similarly between 10 and 200 nm. The thickness and drying conditions may be selected and fine-tuned.

The pretreatment station may be further provided or equipped with a heat and/or humidity dissipation device, optionally provided on or associated with a drying tool, such as a press member. The heat/humidity dissipating device may be provided with an air intake hole/cavity or member, a fan unit, and/or an air/humidity conduit or sleeve that is positioned on one of the device faces and configured to direct heat or humidity from the pretreatment station in a direction of the printing station, to thereby increase humidity in the printing zone. Such an internal humidity diverting capabilities may render unnecessary misting means typically used in a vicinity of a printing assembly.

The object onto which an image is to be formed using a system or a process of the invention, may be an object having a surface of any material composition. The recipient surface region is typically a flat surface. It may be a surface of a solid object, a flexible object, texture objected, a fibrous object, etc. The object may thus be a metallic object, a polymeric object, a paper-based object, a fabric or a textile, glass, a ceramic object and objects hybrid surface compositions.

In some embodiments, the object is a fabric or a textile or an object which is formed of or containing a fabric or a textile. In some embodiments, where the object is a fabric or a textile, the support surface may be a flat surface configured to fixedly hold the fabric or textile.

The fabric or textile (as each known in the art) may be in a form of a yarn or a sheet-like object, that may be a single sheet or a plurality of sheets which surfaces are positioned parallel to each other. The textile or fabric may be a woven or a non-woven material, which may or may not be formed of a natural fiber, a synthetic fiber, or a combination of the two. Non-limiting examples of textiles and fabrics include such comprised or formed of polyester fibers, polyurethane fibers, polyethylene fibers, polyamide fibers, polyacryl fibers, polybenzimidazole fibers, Nylon, Dacron fibers, Modacryl fibers, Rayon fibers, Viscose Rayon fibers, acetate fibers, Saran fibers, Spandex fibers, Vinalon fibers, Aramid fibers, Elastane fibers, cellulose fibers, linen fibers, Flax fibers, Hemp fibers, cotton fibers, silk fibers, wool fibers and others.

An object formed of such a fabric or a textile may be an unprocessed yarn or a clothing object, an ornamental object, or any other such object known in the art, including for example, clothing, carpeting, upholstered furnishings, window shades, towels, coverings for tables, beds, and technical textiles.

In some embodiments, the object is a clothing or a garment. Non-limiting examples include a sweater, a jacket, a shirt, a T-shirt, a coat, pants, socks, shorts and others.

A printing system of the invention may further include two or more fluid reservoirs that are in liquid communication with respective deposition tools provided for depositing a pretreatment formulation or an ink formulation. At least one of the fluid reservoirs is an ink reservoir in liquid communication with the printing assembly of the printing station. At least one another of the fluid reservoirs is a pretreatment reservoir in liquid communication with the film forming tool of the pretreatment station.

Each of the object stream may be provided with an optical scanner or sensor, such as a barcode reader or an RFID reader, that is configured to identify information coded on a barcode or an RFID assigned to each of the objects or to a plurality or groups of objects and relay the information (such as a processing profile) to a respective control unit that is configured to instruct operation of a specific printing protocol instructing the type of pretreatment formulation to be used, the amount of formulation to be used, the image(s) to be formed, curing or drying temperatures, the duration of the curing or drying step, etc. The system may also comprise a system control system for instructing operation of the system as a whole, including the conveyor, and/or the pretreatment station and/or the printing station sequentially or simultaneously based on a predefined printing protocol.

The printing system may be controlled through instructions executed by a computer-based control system, that may include processors connected to a communication bus, volatile memories such as random access memory (RAM) or non-volatile memories. Computer programs may be loaded from a secondary memory into a main memory for execution by one or more processors of the control system, or computer programs may be received via a wired and/or wireless communication interface.

The system control unit may be associated with a motion encoder that is independently associated with the conveyor and/or the pretreatment tools and/or the printing assembly to transmit positional control signal(s) to instruct the conveyor to move the objects from one station to another, to instruct the arresting of movement, to instruct the printing assembly or the individual print head units to eject a material composition in a direction of the object surface, and/or instruct operation of the pretreatment tools, based on a predefined printing protocol, that is intended for printing a pattern on the object surface. The control unit may thus be used to operate a sequence of movements including movement of the conveyor to cause transition of the support platform from one station to another along the closed-loop track, to operate the film forming and drying tools of the pretreatment station to form a film of a pretreatment formulation on a predefined region(s) of the object surface, to operate the printing assembly to deposit ink onto a region of the object surface precoated with a film of a pretreatment, etc.

A system of the invention may be configured to operate with different specifications. An exemplary specification is provided in Table 1.

| | |
|---|---|
| Number of print platens | 2 |
| Number of print heads | 5, 8, 10 or 13 |
| Ink type: | Water-based pigment ink |
| | Oeko-Tex Eco-Passport and GOTS 7 certified |
| Colors | CMYKW, Double CMYKW, Optional Green, |
| | Orange & Blue |
| In-line automatic | Standard |
| pre-treatment system | |
| In-line Pre-treatment | Standard |
| drying system: | |
| In-line ironing | Standard |
| thread flattening | |
| Productivity | Up to 360 garments per hour* |
| Max. Print area: | 60 × 90 cm/23.6 × 35.4 in |
| Printable Fabrics | Cotton, synthetics, mixed fibers, leather |
| | and more |
| Printer size | |
| Printer weight | |
| Electrical requirements | 400/208 VAC, 50/60 Hz, 3 Ph, |
| | 16 A - max power input: 7.5 kVA |
| Compressed air | 7 bar |
| Environmental | Temperature: 22-28° C., |
| conditions | Humidity: 65-90% |

The treatment formulations used in systems and methods of the invention may be any such formulation known in the art. Typically, such formulations may be aqueous or solvent-based formulations comprising cationic materials, fixation agents and/or additives. Such formulations are known from example from International Patent Publication Nos. WO2022/234553, WO2017/081694, and WO2022/234553, and International Patent Application Nos. PCT/IL2023/050578 and PCT/IL2023/050835, wherein the pretreatment formulations disclosed in each reference is herein incorporated by reference.

The ink formulations used in forming images on the dry pretreatment films, may be any water-based ink formulations. The ink may comprise a carrier, additives and a pigment or a dye. The colored pigments may be:
white pigments such as titanium dioxide; and
colored pigments known, for example, under the color index (C.I.):
C.I. Pigment Yellow 1, 2, 3, 4, 5, 6, 10, 12, 13, 14, 16, 17, 24, 55, 61, 65, 73, 74, 81, 83, 93, 94, 95, 97, 99, 100, 108, 109, 110, 117, 120,123, 124, 128, 129, 133, 138, 139, 147, 150, 151, 153, 154, 155, 156, 167, 168, 172, 173, 174, 175, 176, 177, 179, 180, 181, 182, 183, 184, 185, 187, 188, 190,191, 192, 193, 194 and others;
C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48, 49, 50, 51, 52, 53, 55, 60, 64, 68, 81, 83, 87, 88, 89, 90, 95, 112, 114, 119, 122, 123, 136, 144, 146, 147, 148, 149, 150, 151, 163, 164, 166, 168, 169, 170, 161, 172, 175, 176, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264 and others;
C.I. Pigment Violet 1, 2, 3, 5, 13, 19, 23, 25, 27, 29, 31, 32, 37, 39, 42, 44, 50 and others;
C.I. Pigment Blue 1, 2, 3, 9, 10, 14, 15, 16, 18, 19, 21, 22, 24, 25, 56, 60, 61, 62, 63, 64, 65, 66, and others;
C.I. Pigment Orange 1, 2, 5, 6, 7, 13, 14, 15, 16, 17, 19, 22, 24, 31, 34, 36, 38, 40, 42, 43, 44, 46, 48, 49, 51, 59, 60, 61, 62, 63, 64, 65, 66, 67, 68, 69 and others;
C.I. Pigment Green 1, 2, 4, 7, 8, 10, 34, 36, 45, 47, and others;
C.I. Pigment Brown 1, 2, 3, 5, 22, 23, 25, 26, 32, 38, 41, 42 and others;
C.I. Pigment Black 1, 7, 20, 31, 32 and others.

The invention further contemplates a process of printing an image(s) on a surface region of an object, the process comprising
advancing two or more streams of objects along two or more predefined closed-loop printing tracks traversing a pretreatment station and a printing station,
operating at least one film-forming tool provided in said pretreatment station to affect deposition of a pretreatment formulation on a surface region of an object in one or each of the two or more streams of objects (e.g., to form a film of said formulation) and
operating at least one print head unit to apply one or more patterns, forming the image on the surface region of an object (in each of the two or more streams) deposited with the pretreatment formulation.

Each of the embodiments herein relating to a system of the invention, equally constitute embodiment of methods and processes of the invention.

In some embodiments of the process, the process comprises loading one or more objects onto a support surface configured for each of the one or more objects and operable to move along a predefined two or more closed-loop printing tracks. In some embodiments, each of the support surfaces is mounted on a conveyor.

In some embodiments, the one or more streams of objects comprises a plurality of objects, each mounted on a support surface movable along a track.

In some embodiments, the process comprises depositing the pretreatment formulation to obtain a film on the surface region of the object. In some embodiments, the film is thermally treated to induce drying. In some embodiments, drying is achieved by a heated press member pressing the wet film.

In some embodiments, the process comprises drying and/or curing the image formed.

In some embodiments, the process comprises off-line drying and/or curing of the image formed.

In some embodiments, the process comprises:
Loading one or two or more objects, e.g., garments, onto one or two or more platens;
Transitioning the one or two or more platens to a pretreatment station, optionally positioned at a level lower to the level of a printing station;
Applying a pretreatment formulation onto each of the objects, e.g., garments;
Drying each of the objects by hot air and subsequently by a heated press member, to optionally also flatten the object fibers;
Transitioning the platens to the printing station, optionally provided at a level higher to the level of the pretreatment station;
Forming an image on the dry pretreatment film at the printing station;
Optionally drying or curing the image; and
Transitioning the processed object to the unloading station (which may be the same station as the loading station).

Aspects and embodiment of the invention disclosed above thus include:

A printing system comprising a conveyor system and a plurality of processing stations, the conveyor system comprising two or more closed-loop tracks, each track defining an object stream independently controllably transitioned by the conveyor system through the plurality of processing stations, each of the closed-loop tracks being equipped with a plurality of support surfaces adapted to receive same or different object; the plurality of processing stations comprises a loading zone; a pretreatment station equipped with one or more film deposition tools for forming a wet pretreatment film of a pretreatment formulation on a surface of the object and one or more drying tools configured to dry the wet film formed on the surface of the object; a printing station equipped with one or more print heads or a print head assembly or an array of print heads arranged and operable to form an image on a surface region of the dry film; and optionally a drying or curing station configured for drying or curing the image.

In some embodiments of any of the systems of the invention, the pretreatment station is equipped with a heating press member configured to contact the wet pretreatment film for a period of time sufficient to cause drying.

In some embodiments of any of the systems of the invention, the heating press member uniformly acts on the wet surface and applies pressure for a period of time sufficient to dry the wet film.

The invention contemplates a printing system comprising a conveyor system and a plurality of processing stations, the conveyor system comprising two or more closed-loop tracks, each track defining an object stream independently controllably transitioned by the conveyor system through the plurality of processing stations, each of the closed-loop tracks being equipped with a plurality of support surfaces adapted to receive same or different object;
the plurality of processing stations comprises a loading zone; a pretreatment station equipped with one or more film deposition tools for forming a wet pretreatment film of a pretreatment formulation on a surface of the object and one or more drying tools configured to dry the wet film formed on the surface of the object, wherein the one or more drying tools comprises a heating press member configured to contact press the wet film for a period of time sufficient to dry the film; a printing station equipped with one or more print heads or a print head assembly or an array of print heads arranged and operable to form an image on a surface region of the dry film; and optionally a drying or curing station configured for drying or curing the image.

In some embodiments of any of the systems of the invention, the heat press member contacts the wet film for a period of between 1 second and 120 seconds or between 10 and 90 seconds or between 15 and 90 seconds, or between 20 and 90 seconds, or as disclosed herein.

In some embodiments of any of the systems of the invention, the heating press member is operable at a temperature no greater than 200° C.

In some embodiments of any of the systems of the invention, each of the support surfaces are aligned with respect to support surfaces in other object streams and with respect to any one of the processing stations and are synchronized to move all object streams at the same rate.

In some embodiments of any of the systems of the invention, the conveyor is configured to cease movement of the object streams when reaching a processing station for a period of time sufficient to allow a printing process step and/or a pretreatment step and/or the drying step and/or a loading and unloading step to be carried out.

In some embodiments of any of the systems of the invention, the loading zone comprises a loading station and an unloading station.

In some embodiments of any of the systems of the invention, the loading station and the unloading stations are same and occupy same region of the loading zone.

In some embodiments of any of the systems of the invention, the loading zone configured to receive, manually or automatically, for every object stream, one or more objects to be processed according to a predefined processing protocol, and to allow for unloading of objects after the objects have transitioned through the processing stations.

In some embodiments of any of the systems of the invention, the loading zone is equipped with a loading/unloading robotic unit.

In some embodiments of any of the systems of the invention, the pretreatment station is positioned upstream to the loading station and is configured and operable to prime the object surface to receive thereon an ink formulation.

In some embodiments of any of the systems of the invention, the pretreatment station comprises one or more film forming tools for depositing a wet film of one or more types of pretreatment formulations onto a surface region of the object intended to be patterned or printed on and one or more drying tools for drying the wet film of the pretreatment formulation or for increasing the wet film viscosity to a degree suitable for receiving an ink formulation thereon.

In some embodiments of any of the systems of the invention, one or more film forming tools comprise a printing assembly configured and operable to form the wet film or an electrically operated spraying unit, or brushing unit.

In some embodiments of any of the systems of the invention, the one or more drying tools comprises one or more IR lamp; or one or more heating member; or a heating surface positioned to emit thermal radiation from above and/or below the object.

In some embodiments of any of the systems of the invention, the one or more drying tools comprises a hot air source.

In some embodiments of any of the systems of the invention, the one or more drying tools is selected to emit thermal energy sufficient to heat the surface of the object to a temperature not exceeding 200° C.

In some embodiments of any of the systems of the invention, a system further comprising a curing or a drying station positioned upstream to the printing station.

In some embodiments of any of the systems of the invention, the curing or drying station comprises one or more sources of a UV or thermal radiation configured to emit UV or thermal radiation in a directed of the object.

In some embodiments of any of the systems of the invention, the source of thermal radiation is selected from an IR lamp, a heated element or surface, and hot air, wherein the source is operable to direct thermal radiation in a direction of the image formed on the object traversing through the drying station.

In some embodiments of any of the systems of the invention, the support surface is configured to simultaneously carry one or more objects and transition said objects along the processing stations.

In some embodiments of any of the systems of the invention, the support surface allows for fixed and reversible association to the object.

In some embodiments of any of the systems of the invention, the printing station is equipped with a printing assembly configured and operated for printing on a dry pretreatment film formed on the surface of the object traversing the printing station.

In some embodiments of any of the systems of the invention, the printing assembly comprises one or more print head units or a print head assembly, or an array or a plurality of print head units.

In some embodiments of any of the systems of the invention, each of the printing head units includes one or more jet nozzles for ejecting an ink formulation in a direction of the dry pretreatment film.

In some embodiments of any of the systems of the invention, the printing assembly is provided on a movable support bridge or on a raised movable platform positioned above and optionally perpendicular to an axis defined by a path of the conveyor, wherein the printing assembly is configured and operable to affect movement along an axis of the bridge, in a direction perpendicular to the axis of the bridge and/or to a direction above and below the axis of the bridge.

In some embodiments of any of the systems of the invention, the movable support bridge is mounted on a pair of parallel fixed support tracks and is configured for slidingly transition between any two points along the fixed support tracks, within the printing station, along the axis defined by the path of the conveyor.

In some embodiments of any of the systems of the invention, the object is a flat object or an object having a flat surface.

In some embodiments of any of the systems of the invention, the object is a solid object, a flexible object, a textured object, or a fibrous object.

In some embodiments of any of the systems of the invention, the object is a metallic object, a polymeric object, a paper-based object, a fabric or a textile, glass, a ceramic object and an object having a hybrid surface composition.

In some embodiments of any of the systems of the invention, the object is a fabric or a textile.

The invention contemplates also a printing system for forming an image on a garment, the system comprising a conveyor system and a plurality of processing stations, the conveyor system comprising two or more closed-loop tracks, each track defining an object stream independently controllably transitioned by the conveyor system through the plurality of processing stations, each of the closed-loop tracks being equipped with a plurality of support surfaces adapted to receive same or different garment;
the plurality of processing stations comprises a loading zone; a pretreatment station equipped with one or more film deposition tools for forming a wet pretreatment film of a pretreatment formulation on a surface of the garment and one or more drying tools configured to dry the wet film formed on the surface of the garment, wherein the one or more drying tools comprises a heating press member configured to contact press the wet film for a period of time sufficient to dry the film and flatten the garment; a printing station equipped with one or more print heads or a print head assembly or an array of print heads arranged and operable to form an image on a surface region of the dry film; and optionally a drying or curing station configured for drying or curing the image.

In some embodiments of any of the systems of the invention, a system further comprising two or more fluid reservoirs that are in liquid communication with respective deposition tools provided for depositing a pretreatment formulation or an ink formulation.

In some embodiments of any of the systems of the invention, comprising an optical scanner or sensor configured to identify information coded on a tag assigned to each of the objects or to a plurality or groups of objects and relay the information to a respective control unit configured to instruct operation of a specific processing profile relating to the object.

In some embodiments of any of the systems of the invention, the tag is a barcode or an RFID tag.

In some embodiments of any of the systems of the invention, the processing profile comprising instructions relating to a type of pretreatment formulation to be used, an amount of formulation to be used, an image(s) to be formed, curing or drying temperatures, and duration of a curing or drying step.

In some embodiments of any of the systems of the invention, a system comprising a control system for instructing operation of the system, or any of the system parts, in sequence or simultaneously, based on a predefined printing protocol.

In some embodiments of any of the systems of the invention, the control unit is associated with a motion encoder independently associated with the conveyor and/or the pretreatment deposition and drying tools and/or the printing assembly to transmit positional control signal(s) to instruct the conveyor to move the objects from one station to another, to instruct the arresting of movement, to instruct the printing assembly or the individual print head units to eject a material composition in a direction of the object surface, and/or instruct operation of the pretreatment tools, based on a predefined object processing profile.

In some embodiments of any of the systems of the invention, the control is configured and operable to instruct a sequence of movements comprising movement of the conveyor to cause transition of the support platform from one station to another along the closed-loop track, to operate the film forming and drying tools of the pretreatment station to form a dry film of a pretreatment formulation on a predefined region(s) of the object surface, and to operate the printing assembly to deposit ink onto a region of the object surface precoated with a film of a pretreatment formulation.

The invention further contemplates a process of printing an image on a surface region of an object, the process comprising
advancing two or more streams of objects along two or more predefined closed-loop printing tracks traversing a pretreatment station and a printing station,
operating at least one film-forming tool provided in said pretreatment station to affect deposition of a wet film of a pretreatment formulation on a surface region of an object in each of the two or more streams of objects and operating a drying tool to cause drying of the wet film;
advancing the object having the dry film on its surface to a printing station and operating at least one print head unit to apply one or more patterns, forming the image on the surface region of the dry film.

In some embodiments of any of the processes of the invention, a process comprising advancing two or more objects simultaneously, wherein each object is associated with a different processing profile.

In some embodiments of any of the processes of the invention, each of the objects having different processing profiles is formed with a different pretreatment formulation, ink formulation and/or deposition conditions.

In some embodiments of any of the processes of the invention, each object is associated with a tag identifying an independent processing profile.

In some embodiments of any of the processes of the invention, a process comprising forming the wet film by spraying or brushing or printing the film onto a surface region of the object.

In some embodiments of any of the processes of the invention, the wet film is dried by content pressing with a heating press member.

In some embodiments of any of the processes of the invention, a process comprising loading one or more objects onto one or a plurality of support surfaces configured and operable to move along the predefined two or more closed-loop printing tracks.

In some embodiments of any of the processes of the invention, each of the support surfaces is mounted on a conveyor.

In some embodiments of any of the processes of the invention, carried out on a system according to the invention.

In some embodiments of any of the processes of the invention, the object is a fabric or a textile.

The invention contemplates a process of printing an image on a surface region of a garment, the process comprising
advancing two or more streams of garments along two or more predefined closed-loop printing tracks traversing a pretreatment station and a printing station,
operating at least one film-forming tool provided in said pretreatment station to affect deposition of a wet film of a pretreatment formulation on a surface region of the garments in each of the two or more streams of objects and operating a drying tool to cause drying of the wet film;
advancing each garment having the dry film on its surface to a printing station and operating at least one print head unit to apply one or more patterns, forming the image on the surface region of the dry film.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 provides a schematic depiction of a closed-loop system according to some embodiments of the invention.

FIG. 2 provides a side-view depiction of a system of the invention.

FIG. 3 provides a depiction of a system according to certain embodiments of the invention having two object streams.

FIGS. 4A-B provide (A) a top view and (B) a side view of a two-object stream system comprising a plurality of carriages.

FIG. 5 provides a depiction of a pretreatment station according to some embodiments of the invention.

### DETAILED DESCRIPTION OF EMBODIMENTS

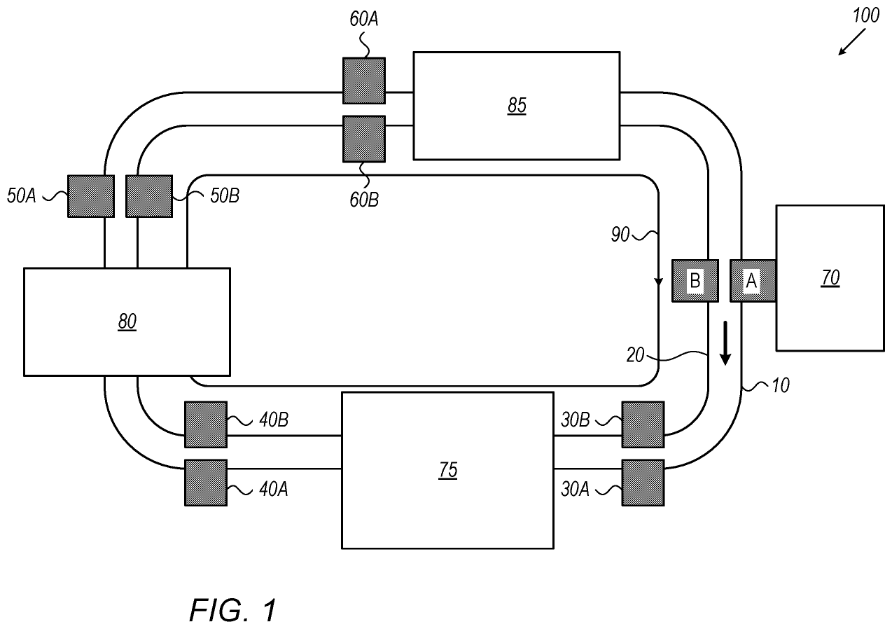

To illustrate a system of the invention, FIGS. 1 through 5 are provided as schematic and partial illustrations of a system according to certain non-limiting embodiments of the invention.

FIG. 1 is a schematic representation of a closed-loop system 100 according to the invention. The Figure depicts a two-track system comprising tracks 10 and 20 positioned on a conveyor system and provided with a plurality of carriages or platens or support surfaces exemplified by surfaces 30A and 30B, 40A and 40B, 50A and 50B, 60A and 60B. additional or a lesser number of such surfaces may be provided. The distance and distribution of surfaces depicted is not limiting and is provided for demonstration purposes only. Each surface is mounted at a predefined location of the track 10 or 20. Several processing stations are depicted. Additional stations may be incorporated. Loading zone 70 is provided downstream or before the processing stations: pretreatment station 75, printing station 80 and the curing or drying station 85 (which may or may not be present). The object stream flows in a direction depicted by arrow 90.

As demonstrated, two loaded surfaces A and B, each defining an independent object stream, positioned proximate to the loading zone, travel in the direction of depicted by the arrow along the processing path depicted by arrow 90. Upstream to the loading zone are the pretreatment station 75 and the printing station 80, each equipped as disclosed herein to provide a dry pretreatment film on the object and a subsequent image on the dry film.

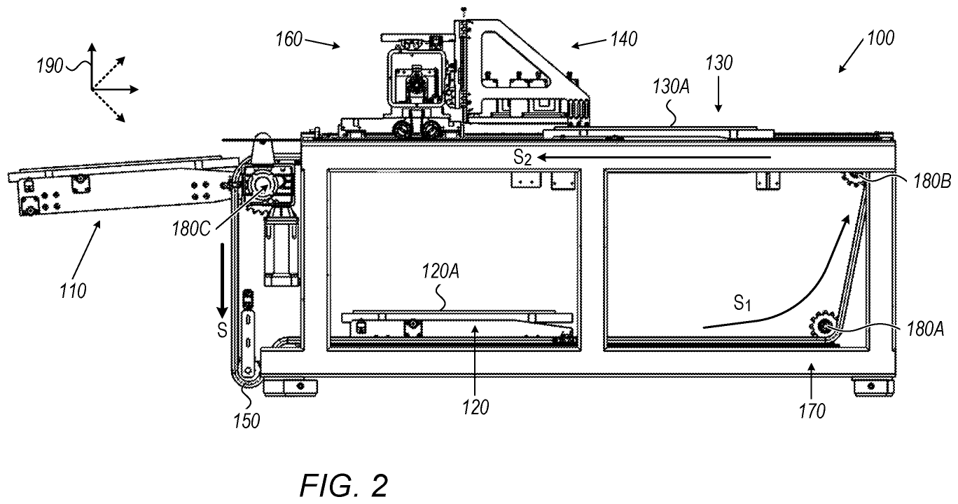

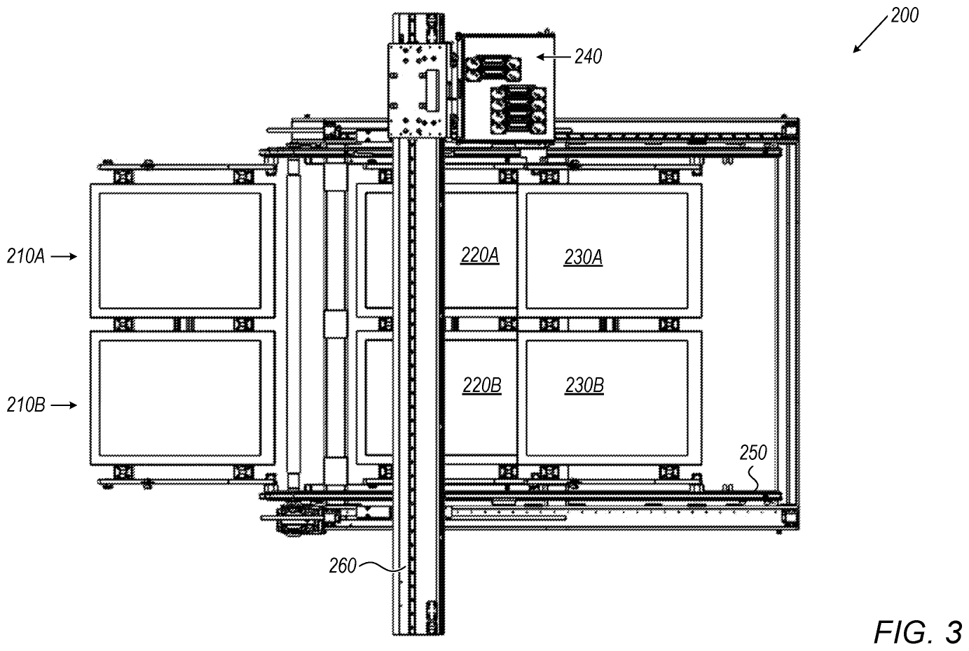

In some configurations, the pretreatment station may be positioned at a level lower than that occupied by the printing station, as depicted in FIGS. 2 and 3.

FIG. 2 depicts a side view of system 100 showing some of the system stations. As depicted, the system comprises a closed-loop track configured to manage at least one stream of objects from a loading zone 110 through one or more in-line processing stations 120 and 130 and back to the loading zone 110 where the object is unloaded from the closed-loop track and a new object may be loaded. Objects moving along the object stream identified by S, S1 and S2 are controllably transitioned by a conveyor system 150 that transitions any of the objects through each of the in-line processing stations 120 and 130 along the track, provided with support surfaces 120A and 130A, typically in a form of flat carriages, that are aligned with respect to any of the processing stations and configured to transition from one processing station to another along the track at a rate that may be same or different from a rate of movement within a particular processing station. Additional carriages may be included.

The closed-loop track is housed within a digital printing process space 170 and is configured and operable to occupy a three-dimensional spaced within the housing such that at least one of the processing stations, such as the pretreatment station 120, may be provided at a level that is different from a level defined by another of the processing stations, such as the printing station 130.

The closed-loop track may comprise a pretreatment station 120 and a printing station 130. The pretreatment station 120 is positioned upstream to the loading zone 110. The printing station 130 provided along the closed-loop track, upstream to the pretreatment station 120, is configured and operable for printing by one or more printing head units or by at least one array of printing head units 140.

The conveyor 150 defining a movement path along which the support surfaces travel may include two or more drive pulleys 180A, 180B, 180C that are electrically powered.

The printing assembly 140 may include one or more print head units or a print head assembly, or an array of a plurality of print head units. The units may be arranged along a single axis above and perpendicular to a translation axis defined by a path of the conveyor and the support surfaces mounted thereon traversing the printing station, or arranged in spaced apart regions of the printing station along the path of the conveyor and the support surfaces to allow for simultaneous or sequential printing on different regions of the object surface. In some configurations, the printing assembly is provided on a movable support bridge 160 or on a raised movable platform that is positioned above and optionally perpendicular to the axis defined by the path of the conveyor and the support surfaces mounted thereon, wherein the printing assembly is configured and operable to affect movement along the axis of the bridge, in a direction perpendicular to the axis of the bridge and/or to a direction above and below the axis of the bridge, namely in all directions 190 with respect to the bridge.

The movable support bridge 160 on which the printing assembly may be mounted on a pair of two parallel fixed support tracks and may be configured for slidingly transition (back and forth along the same axis) between any two points along the fixed support tracks, within the printing section, along the axis defined by the path of the conveyor and the support surfaces mounted thereon. The movement of the bridge combined with movement of the printing assembly allows for a multi-pass for achieving correction of printing defects, or for making prints of greater complexity.

FIG. 3 depicts a system 200 having a support surface that is structured to operate two independent object streams 210A and 210B movable through a shared pretreatment station as support surfaces 220A and 220B and further traversing a shared printing station as support surfaces 230A and 230B. The system comprises a conveyor 250, a printing assembly 240 and a mounting bridge 260.

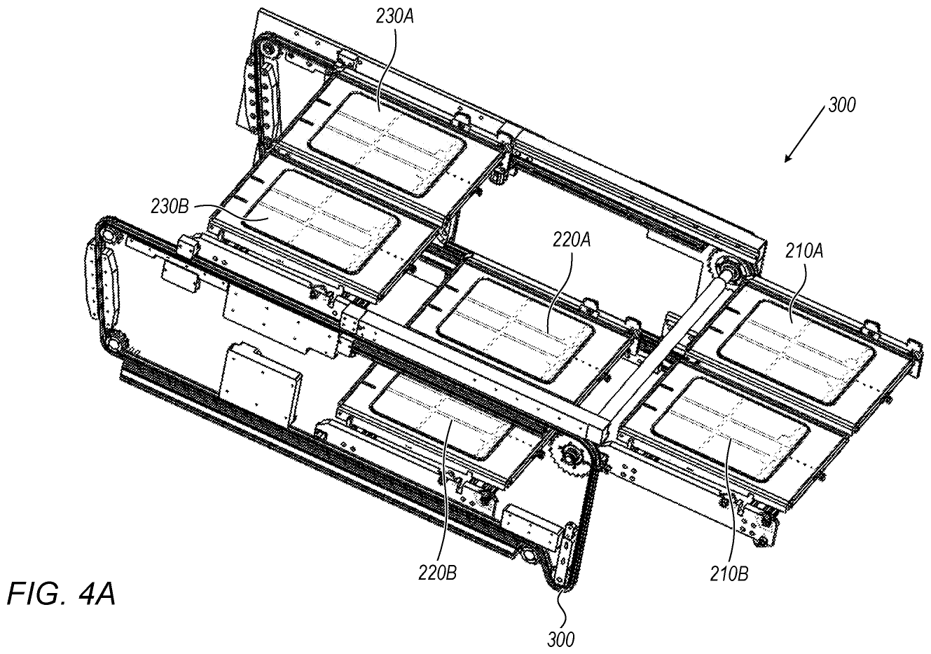

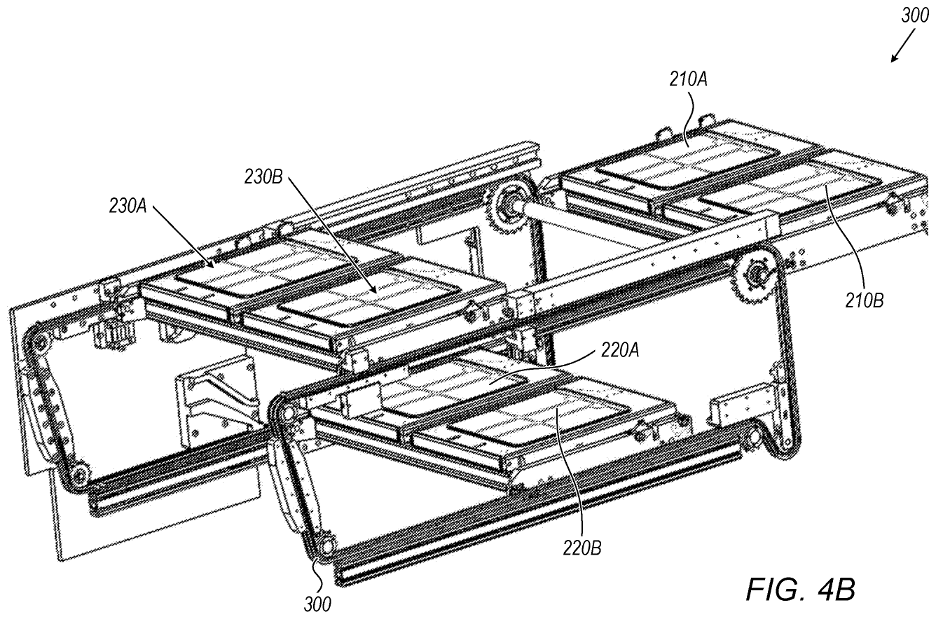

FIGS. 4A and B depict a top view and a side view of a two-object stream system as depicted in FIG. 3, comprising a plurality of carriages. As shown, carriages 220A and 220B are at a position that is lower than the position of the other carriages 230A and 230B. All carriages are carried on a track or a plurality of tracks mounted on a conveyor 300.

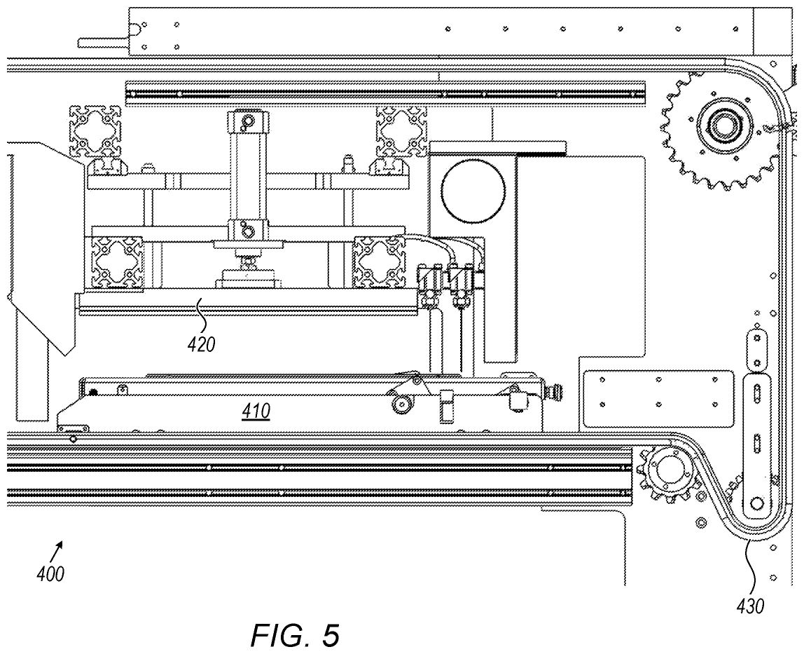

FIG. 5 provides a depiction of a pretreatment station. according to some embodiments of the invention. The pretreatment station 400 is provided with a heating press member 420 that is position above and parallel to a carriage 410 positioned at the station. Following deposition of a wet pretreatment film, the press member 420 is lowered onto the wet film and applies a pressure and heat that dries the wet film.

1.-51. (canceled)

52. A printing system comprising a conveyor system and a plurality of processing stations, the conveyor system comprising two or more closed-loop tracks, each track defining an object stream independently controllably transitioned by the conveyor system through the plurality of processing stations, each of the closed-loop tracks being equipped with a plurality of support surfaces adapted to receive same or different object;
the plurality of processing stations comprises a loading zone; a pretreatment station equipped with one or more film deposition tools for forming a wet pretreatment film of a pretreatment formulation on a surface of the object and one or more drying tools configured to dry the wet film formed on the surface of the object; a printing station equipped with one or more print heads or a print head assembly or an array of print heads arranged and operable to form an image on a surface region of the dry film; and optionally a drying or curing station configured for drying or curing the image.

53. The system according to claim 52, wherein the pretreatment station is equipped with a heating press member configured to contact the wet pretreatment film for a period of time sufficient to cause drying.

54. The system according to claim 53, wherein the heating press member uniformly acts on the wet surface and applies pressure for a period of time sufficient to dry the wet film.

55. The system according to claim 52, wherein the loading zone configured to receive, manually or automatically, for every object stream, one or more objects to be processed according to a predefined processing protocol, and to allow for unloading of objects after the objects have transitioned through the processing stations.

56. The system according to claim 52, wherein the pretreatment station is positioned upstream to the loading station and is configured and operable to prime the object surface to receive thereon an ink formulation.

57. The system according to claim 56, wherein the pretreatment station comprises one or more film forming tools for depositing a wet film of one or more types of pretreatment formulations onto a surface region of the object intended to be patterned or printed on and one or more drying tools for drying the wet film of the pretreatment formulation or for increasing the wet film viscosity to a degree suitable for receiving an ink formulation thereon.

58. The system according to claim 52, wherein the one or more drying tools comprises a hot air source.

59. The system according to claim 52, further comprising a curing or a drying station positioned upstream to the printing station.

60. The system according to claim 52, wherein the printing station is equipped with a printing assembly configured and operated for printing on a dry pretreatment film formed on the surface of the object traversing the printing station.

61. The system according claim 60, wherein the printing assembly comprises one or more print head units or a print head assembly, or an array or a plurality of print head units.

62. The system according to claim 60, wherein the printing assembly is provided on a movable support bridge or on a raised movable platform positioned above and optionally perpendicular to an axis defined by a path of the conveyor, wherein the printing assembly is configured and operable to affect movement along an axis of the bridge, in a direction perpendicular to the axis of the bridge and/or to a direction above and below the axis of the bridge.

63. The system according to claim 62, wherein the movable support bridge is mounted on a pair of parallel fixed support tracks and is configured for slidingly transition between any two points along the fixed support tracks, within the printing station, along the axis defined by the path of the conveyor.

64. A printing system for forming an image on a garment, the system comprising a conveyor system and a plurality of processing stations, the conveyor system comprising two or more closed-loop tracks, each track defining an object stream independently controllably transitioned by the conveyor system through the plurality of processing stations, each of the closed-loop tracks being equipped with a plurality of support surfaces adapted to receive same or different garment;
the plurality of processing stations comprises a loading zone; a pretreatment station equipped with one or more film deposition tools for forming a wet pretreatment film of a pretreatment formulation on a surface of the garment and one or more drying tools configured to dry the wet film formed on the surface of the garment, wherein the one or more drying tools comprises a heating press member configured to contact press the wet film for a period of time sufficient to dry the film and flatten the garment; a printing station equipped with one or more print heads or a print head assembly or an array of print heads arranged and operable to form an image on a surface region of the dry film; and optionally a drying or curing station configured for drying or curing the image.

65. The system according to claim 52, comprising an optical scanner or sensor configured to identify information coded on a tag assigned to each of the objects or to a plurality or groups of objects and relay the information to a respective control unit configured to instruct operation of a specific processing profile relating to the object.

66. The system according to claim 65, wherein the tag is a barcode or an RFID tag.

67. The system according to claim 52, comprising a control system for instructing operation of the system, or any of the system parts, in sequence or simultaneously, based on a predefined printing protocol.

68. A process of printing an image on a surface region of an object, the process comprising
advancing two or more streams of objects along two or more predefined closed-loop printing tracks traversing a pretreatment station and a printing station,
operating at least one film-forming tool provided in said pretreatment station to affect deposition of a wet film of a pretreatment formulation on a surface region of an object in each of the two or more streams of objects and operating a drying tool to cause drying of the wet film,
advancing the object having the dry film on its surface to a printing station and operating at least one print head unit to apply one or more patterns, forming the image on the surface region of the dry film.

69. The process according to claim 68, comprising advancing two or more objects simultaneously, wherein each object is associated with a different processing profile.

70. The process according to claim 69, wherein each of the objects having different processing profiles is formed with a different pretreatment formulation, ink formulation and/or deposition conditions.

71. The process according to claim 68, comprising forming the wet film by spraying or brushing or printing the film onto a surface region of the object.
